(19) United States
(12) Patent Application Publication
(10) Pub. No.: US 2011/0011674 A1
(43) Pub. Date: Jan. 20, 2011

(54) LADDER EQUIPPED WITH SAFETY BAR

(76) Inventor: Man Seob KIM, Incheon-city (KR)

Correspondence Address: BERENATO & WHITE, LLC, 6550 ROCK SPRING DRIVE, SUITE 240, BETHESDA, MD, 20817, US

(21) Appl. No.: 12/505,613

(22) Filed: Jul. 20, 2009

(51) Int. Cl. E06C 7/18

(52) U.S. Cl. 182/106

(57) ABSTRACT

A ladder equipped with a safety bar comprises a first support supported on the ground, including a plurality of horizontal bars. A fixed bracket has one end fixed to the upper portion. A second support is rotatably combined with the other end portion of the fixed bracket. A foothold is between the first and second supports and is rotatably combined toward the second support on one side. A safety is installed in a C-shaped fashion toward the front side from the fixed bracket. Rotating devices are installed in the first and second supports. Each of the rotating devices comprises a first circular rotating unit having a groove on the outer circumferential surface. A second circular rotating unit rotatably inserted into the groove. A hinge axis penetrates centers of the first rotating unit and the second rotating unit and axially combines the first and second rotating units.

### FIELD OF THE INVENTION

The present invention relates to a ladder equipped with a safety bar, and more particularly, to a ladder equipped with a safety bar in which support legs are folded to maximize a space efficiency as well as to reduce a transportation cost.

### BACKGROUND OF THE INVENTION

Usually, a special ladder is required for a worker to reach a high work position in order to work at a high place.

Here, ladders required according to height of a work place may differ from one another.

In the case of a working environment that is required at a relatively high position, heavy equipment such as a crane is provided instead of a ladder. However, in the case of a working environment that is required in a building or at a position that is not relatively high, heavy equipment such as a crane has shortcomings that are not efficient in various ways.

That is, even in the case of a working site in a building or a field job site, automatic working equipment such as a crane is not used but ladders are used at a position that is not relatively high.

Here, ladders are available in many forms. Rigid ladders can be leaned against a vertical surface of a wall in a building. Step ladders are hinged in the middle to form an inverted V, with stays to keep the two halves at a fixed angle in which the two halves are supported by each other. Some step ladders may be provided with a small horizontal platform called a platform step, at the top.

The rigid ladders and step ladders can be conveniently used indoors and outdoors due to simple conveyance and inexpensive cost, as advantages, but have limitations in view of height of working environment, as shortcomings.

Of course, ladders may be fabricated lengthily or extensively so that they can be used under a high working environment. However, in the case of the ladders, there are no members that a user relies upon but there are some members that he or she steps on. As a result, it is difficult to offer safety in the working environment.

To supplement this, a tower style worktable made of scaffold assemblies is used, but problems may occur in view of a low efficiency of storage as well as an expensive cost.

To solve the above-described problems, the same applicant as that of this invention filed a Korean Utility-model Registration No. 0412243 on Mar. 17, 2006, entitled “Ladder equipped with a safety bar” in which a safety bar is installed on top of the ladder whose halves are rotated each other, and a foothold providing a working space is installed. Accordingly, even if a working environment is offered at a relatively high position, a worker can work safely.

However, the ladder equipped with a safety bar has the following problems.

Problems have occurred that it is uncomfortable for a worker to carry the ladder for transfer to a working space, and an efficiency for a storage space of keeping the ladder in custody drops.

Of course, the ladders may be conveniently carried and an efficiency of space may be high, in comparison with a tower style worktable. However, problems have occurred that a few workers should lift up the ladder from the surface of the floor or ground, or should load the ladder onto a vehicle, in order to carry it from one place to another.

In addition, in the case of step ladders, users can reduce volume of the step ladders by folding first and second support angles each other on a hinge axis for storage, but problems have occurred that it may cause deficiency in efficiently using upper and lower space of a storage place, and also cause a drop of an efficiency of a truck loading space and an economic efficiency for a transport cost to be incurred when using trucks, even in the case that ladders are loaded onto trucks for transportation.

That is, since a great number of ladders cannot be loaded onto one truck, an economy about transport is lowered.

Of course, although conventional step ladders equipped with a safety bar may be disjointed in order to reduce volume, such a disjointing work is very troublesome.

### SUMMARY OF THE INVENTION

To overcome inconveniences of the conventional art, it is an object of the present invention to provide a ladder equipped with a safety bar, which maximizes an efficiency of a loading space and an economic efficiency for a transport cost to be incurred when using vehicles, by minimizing volume of ladders during storage and transportation.

To accomplish the above object of the present invention, according to an aspect of the present invention, there is provided a ladder equipped with a safety bar, the ladder comprising:

a first support supported on the ground, including a plurality of horizontal bars; a fixed bracket whose one end portion is fixed to the upper portion of the first support;

a second support which is rotatably combined with the other end portion of the fixed bracket;

a foothold that is placed between the first and second supports and is rotatably combined toward the second support on one side, thereby offering a working space;

a safety bar which is installed in a C-shaped fashion toward the front side from the fixed bracket, thereby securing a front-side safety of a worker by preventing the worker from falling down from the foothold to the front side; and rotating devices which are installed in the first and second supports, respectively, and folds and unfolds the first and second supports, wherein each of the rotating devices comprises:

a first circular rotating unit along the outer circumferential surface of which a groove is formed;

a second circular rotating unit which is rotatably inserted into the groove of the first rotating unit; and a hinge axis which penetrates centers of the first rotating unit and the second rotating unit and axially combines the first rotating unit and the second rotating unit each other.

Preferably but not necessarily, an angle of the first support with respect to the ground is larger than that of the second support with respect to the ground.

Preferably but not necessarily, a plurality of insertion holes are formed at both sides of the first and second supports, respectively, and height control devices are further installed in the first and second supports, respectively, wherein each of the height control devices comprises:

a first auxiliary leg in which the first support is slid and the plurality of the insertion holes are installed, and which comprises throughholes communicating with the insertion holes;

a second auxiliary leg in which the second support is slid and which comprises throughholes communicating with the insertion holes; and

control units which are installed in the first and second supports, respectively, and inserted into the throughholes of the first and second auxiliary legs and the insertion holes of the first and second supports, thereby constraining ascent and descent of the first and second supports.

In addition, preferably but not necessarily, intervals between the insertion holes formed in the first support are larger than those of the insertion holes formed in the second support.

In addition, preferably but not necessarily, transport wheels are further installed above the second support.

In addition, preferably but not necessarily, position transfer wheels and foot bars are further installed at both sides of the second auxiliary leg, respectively, and each of the foot bars comprises a support bar which pierces the second auxiliary leg and a close adhesion portion which is placed on one end of the support bar and closely contacts the ground.

In addition, preferably but not necessarily, an auxiliary safety bar which is rotatably combined with on the other end of the fixed bracket, and which is installed in a C-shaped fashion toward the rear side from the fixed bracket, thereby securing a rear-side safety of the worker by preventing the worker from falling down from the foothold to the rear side, is further installed in the fixed bracket.

In addition, preferably but not necessarily, a fixing unit which constrains rotation of the foothold is further installed in the other side of the foothold and fixing holes are further installed in the first and second supports in correspondence to the fixing unit, wherein the fixing unit comprises:

fixing pins which are installed at both sides of the foothold, respectively, and enter into and exit from the fixing holes;

a pair of exit and entrance handles which make the fixing pins enter into and exit from the fixing holes; and

a spring which is installed between the exit and entrance handles.

### BRIEF DESCRIPTION OF THE DRAWINGS

The above and/or other aspects of the present invention will become apparent and more readily appreciated from the following description of the exemplary embodiments, taken in conjunction with the accompanying drawings in which:

FIG. 1 A is a perspective view showing a ladder equipped with a safety bar according to a preferable embodiment of the present invention;

FIG. 1B is a front view showing a foothold and a fixing unit in the ladder equipped with a safety bar according to the preferable embodiment of the present invention;

FIG. 2 is a perspective view showing a state that height of the ladder equipped with a safety bar according to a preferable embodiment of the present invention has been controlled; and

FIGS. 3A to 3D are cross-sectional views showing a series of states that the ladder equipped with a safety bar according to a preferable embodiment of the present invention has been folded.

### DETAILED DESCRIPTION OF THE PREFERRED EMBODIMENT(S)

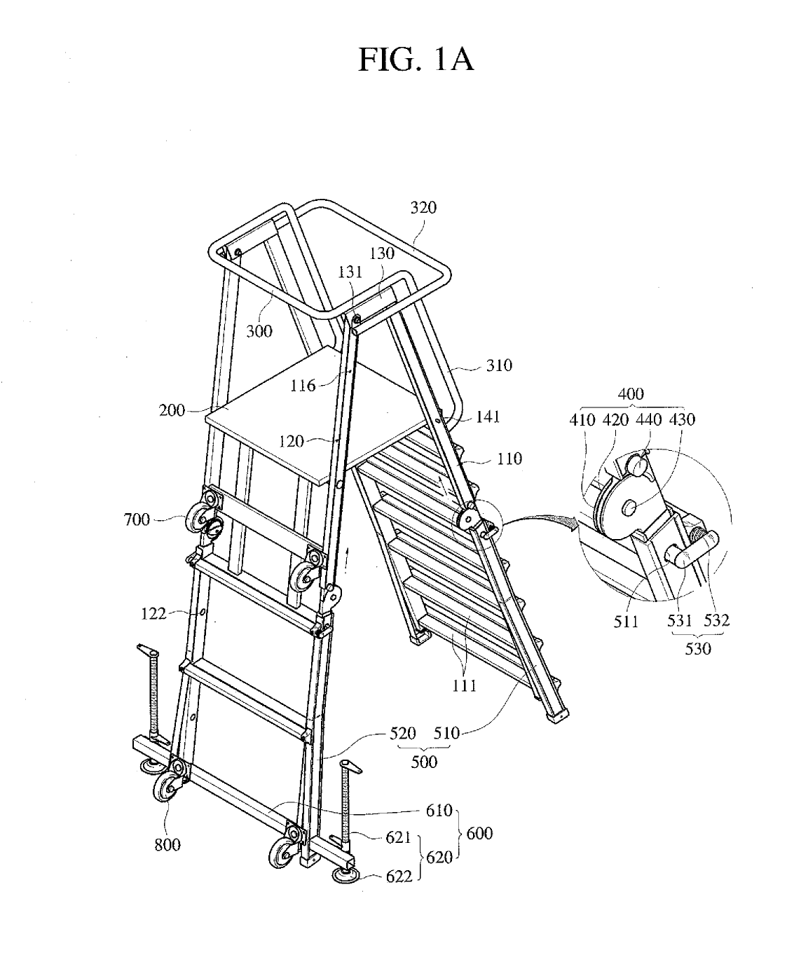

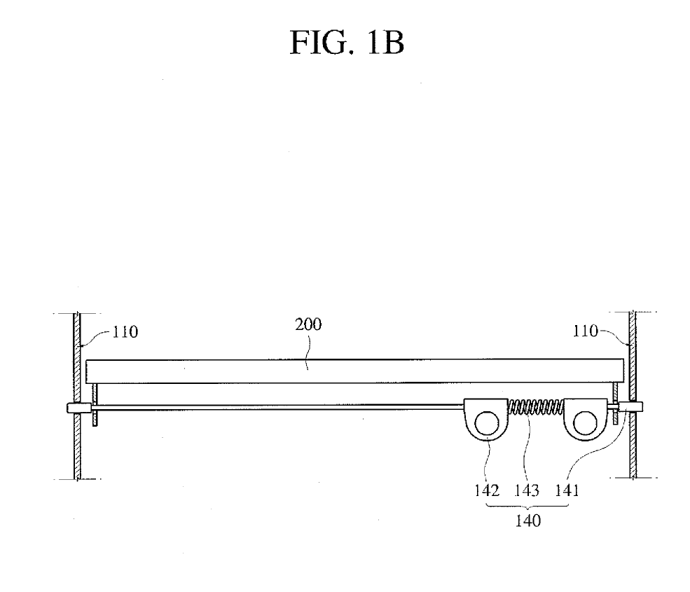

Hereinbelow, a ladder equipped with a safety bar according to a preferable embodiment of the present invention will be described with reference to the accompanying drawings FIGS. 1A to 3D. Like reference numerals are assigned for like elements in the drawings.

A ladder equipped with a safety bar (which will be referred to as a “ladder”) includes a pair of supports 110 and 120, a foothold 200, a safety bar 300, rotating devices 400 and height control devices 500.

The pair of supports 110 and 120 constitute part of the ladder, and are supported onto the ground.

The pair of supports 110 and 120 face each other and include a first support 110 in which a plurality of horizontal bars 111 are installed so that a worker steps up and down the ladder, and a second support 120 which is installed to face the first support 110 so as to be stably supported on the ground.

Here, a fixed bracket 130 is fixed on top of the first support 110.

The fixed bracket 130 plays a role of connecting the second support 120 to the first support 110, and one end portion of the fixed bracket 130 is fixed on top of the first support 110.

The second support 120 is axially combined with the other end of the fixed bracket 130. That is, the second support 120 rotates around axes 131 formed on the first support 110.

Meanwhile, an installation angle α of the first support 110 with respect to the ground is smaller than an installation angle β of the second support 120 with respect to the ground.

This reason is because a worker may go up and down through the horizontal bars 111 conveniently, if the installation angle α of the first support 110 is smaller than the installation angle β of the second support 120.

A plurality of insertion holes 112 and 122 are formed to control height of the ladder step by step at both sides of the first support 110 and the second support 120, respectively.

Here, it is preferable that intervals between the insertion holes 112 formed in the first support 110 are larger than those between the insertion holes 122 formed in the second support 120.

This reason is because height of the ladder may be controlled in parallel when height of the ladder is controlled by a height control device which will be described later, if the intervals between the insertion holes 112 are made to differ from the intervals between the insertion holes 122 by a difference between the installation angles α and β of the first support 110 and the second support 120.

In addition, a first fixing hole 115 is formed in the first support 110, at a position that corresponds to the other side of the foothold 200, and a second fixing hole 116 is also formed in the second support 120 at a position that corresponds to the other side of the foothold 200.

Next, the foothold 200 offers a working space for a worker and is placed between the first and second supports 110 and 120.

It is desirable that the foothold 200 is provided in a flat plate form, and although not illustrated, it is desirable that a nonskid unit such as protrusions is formed on the upper surface of the foothold 200.

In addition, one side of the foothold 200 is rotatably installed around the second support 120, and a fixing unit 140 is rotatably installed at the other side of the foothold 200, so as to be constrained selectively to the first support 110.

The fixing unit 140 includes: fixing pins 141 which enter into and exit from the fixing holes 115 and 116 of the first support 110; a pair of exit and entrance handles 142 which make the fixing pins 141 enter into and exit from the fixing holes 115 and 116; and a spring 143 which is installed between the exit and entrance handles 142.

That is, if the exit and entrance handles 142 approach closely to each other, the spring 143 is contracted, and the fixing pins 141 secede from the first fixing hole 115 of the first support 110. Thereafter, if the exit and entrance handles 142 are released, the exit and entrance handles 142 recede from each other by the spring 143. In this case, the fixing pins 141 are inserted into the first fixing hole 115 of the first support 110.

Next, the safety bar 300 offers a safe working environment for a stand-up worker stepping on the foothold 200, and is installed on the upper portions of the first support 110 and the second support 120, respectively.

Here, it is desirable that the safety bar 300 is installed in the fixed bracket 130 and is formed in a bent fashion after being extended toward the outside of the second support 120, that is, the front side of the ladder.

That is, as illustrated in FIG. 1A when seen from the plane, the safety bar 300 is formed in a C-shaped fashion.

In this case, it is desirable that the safety bar 300 includes a handle 310 that is extended toward the first support 110.

The handle 310 is fixed on both sides of the first support 110, and is provided so that a worker can grasp the handle 310 in the process that the worker goes up and down through the horizontal bars 111.

Meanwhile, it is desirable that an auxiliary safety bar 320 is further installed in the other end of the fixed bracket 130.

The auxiliary safety bar 320 offers rear-side safety for a worker working in the ladder, in order to prevent the worker from falling down from the foothold 200, and is installed toward the rear side of the ladder.

Here, the auxiliary safety bar 320 is rotatably combined with the other end of the fixed bracket 130, and is preferably formed in a C-shaped fashion.

Next, rotating devices 400 are installed in the first and second supports, respectively, in order to fold and unfold the first and second supports.

The rotating devices 400 are preferably installed at substantially middle positions of the first support 110 and the second support 120, respectively.

Accordingly, the first support 110 and the second support 120 can be folded substantially by half.

Here, the rotating devices 400 can be configured so that the first support 110 and the second support 120 may be folded outwards, but it is desirable that the rotating devices 400 can be configured so that the first support 110 and the second support 120 can be folded inwards in order to minimize volume of the ladder.

Meanwhile, each of the rotating devices 400 includes: a first circular rotating unit 410 along the outer circumferential surface of which a groove is formed; a second circular rotating unit 420 which is rotatably inserted into the groove of the first rotating unit 410; and a hinge axis 430 which penetrates centers of the first rotating unit 410 and the second rotating unit 420 and axially combines the first rotating unit 410 and the second rotating unit 420 each other.

Here, in order to help comprehension of explanation, when upper portions of the first support 110 and the second support 120 around the rotating devices 400 are called a first upper support 110a and a second upper support 120a, respectively, and lower portions of the first support 110 and the second support 120 around the rotating devices 400 are called a first lower support 110b and a second lower support 120b, respectively, the first rotating unit 410 is installed on the lower portions of the first upper support 110a and the second upper support 120a, and the second rotating unit 420 is installed on the upper portions of the first lower support 110b and the second lower support 120b.

In this case, it is desirable that locking devices 440 that selectively constrain rotation of the first rotating unit 410 and the second rotating unit 420 are further installed in the rotating devices 400, respectively.

Next, the height control devices 500 play a role of controlling height of the foothold 200 with respect to the ground, and are installed in the first support 110 and the second support 120, respectively.

Here, each of the height control devices 500 includes: a first auxiliary leg 510 configured so that the first support 110 may ascend and descend; a second auxiliary leg 520 configured so that the second support 120 may ascend and descend; and control units 530 which constrain ascent and descent of the first and second supports 110 and 120.

The first auxiliary leg 510 controls height of the first support 110, and includes a plurality of horizontal bars 111.

Here, throughholes 511 that selectively communicate with the insertion holes 112 of the first support 110 are formed in the first auxiliary leg 510.

Also, the second auxiliary leg 520 controls height of the second support 120, and includes a plurality of horizontal bars 111.

Also, throughholes 521 that selectively communicate with the insertion holes 122 of the second support 120 are formed in the second auxiliary leg 520.

And, the control unit 530 constrain ascent and descent of the first and second supports 110 and 120, and each of the control unit 530 includes a pin 531 and a spring 532.

The pin 531 selectively enters into and exits from the throughholes 511 and 521 of the first and second auxiliary legs 510 and 520 and the insertion holes 112 and 122 of the first and second supports 110 and 120, to thereby fix heights of the first support 110 and the second support 120.

Here, one side of the pin 531 is configured to enter into and exit from one side of one of the horizontal bars 111 installed in the first and second auxiliary legs 510 and 520, and the other side of the pin 531 is configured to enter into and exit from the throughholes 511 and 521 of the first and second auxiliary legs 510 and 520 and the insertion holes 112 and 122 of the first and second supports 110 and 120.

In addition, the spring 532 elastically supports exit and entrance of the pin 531, and is installed in the inside of one of the horizontal bars 111.

Here, the spring 532 is installed along the circumference of one side of the pin 531.

Meanwhile, it is preferable that foot bars 600 are further installed at the lower portions of both sides of the second auxiliary leg 520, respectively.

Each of the foot bars 600 plays a role of furthermore reinforcing to prevent the ladder that is supported to the ground from moving, and includes a support bar 610 which pierces the lower portion of the second auxiliary leg 520 and a close adhesion portion 620 which is placed on one end of the support bar 610 and closely contacts the ground.

Here, the support bar 610 pierces the second auxiliary leg 520 and moves selectively, so as to control a support width with respect to the ground.

In addition, the close adhesion portion 620 is closely adhered to the ground to thus maximize a sense of stability of each of the foot bars 600 and includes an escalation portion 621 that ascends and descends up and down and a close adhesion plate 622 closely adhered to the ground.

Meanwhile, it is desirable that wheels that make transfer of the ladder simple are further installed in the second support 120 and the second auxiliary leg 520.

The wheels are classified into transport wheels 700 and position transfer wheels 800.

The transport wheels 700 are provided so that the ladder can be easily transported to a place of storage when volume of the ladder has been minimized because the first support 110 and the second support 120 have been folded, and are installed in the lower portion of the second upper support 120a.

The position transfer wheels 800 are provided so that the ladder can be easily moved when a work position of the ladder is changed at a state where the ladder has been supported to the ground, and are installed in the lower portion of the second auxiliary leg 520.

Here, the position transfer wheels 800 are installed so as to roll on the surface of the ground when the ladder is inclined so that the second support 120 approaches closely to the ground.

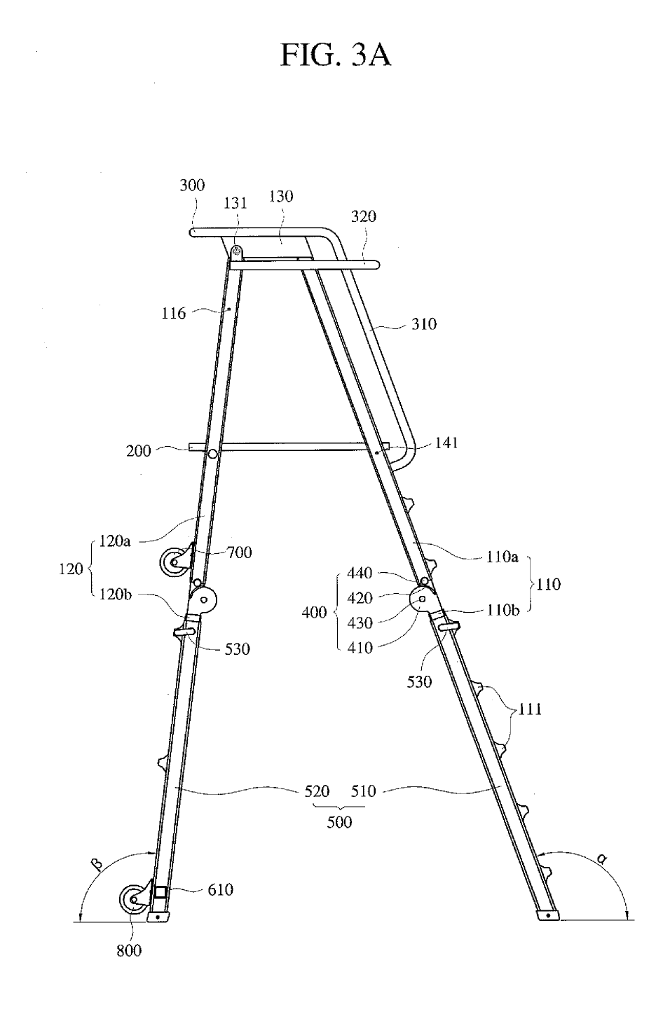

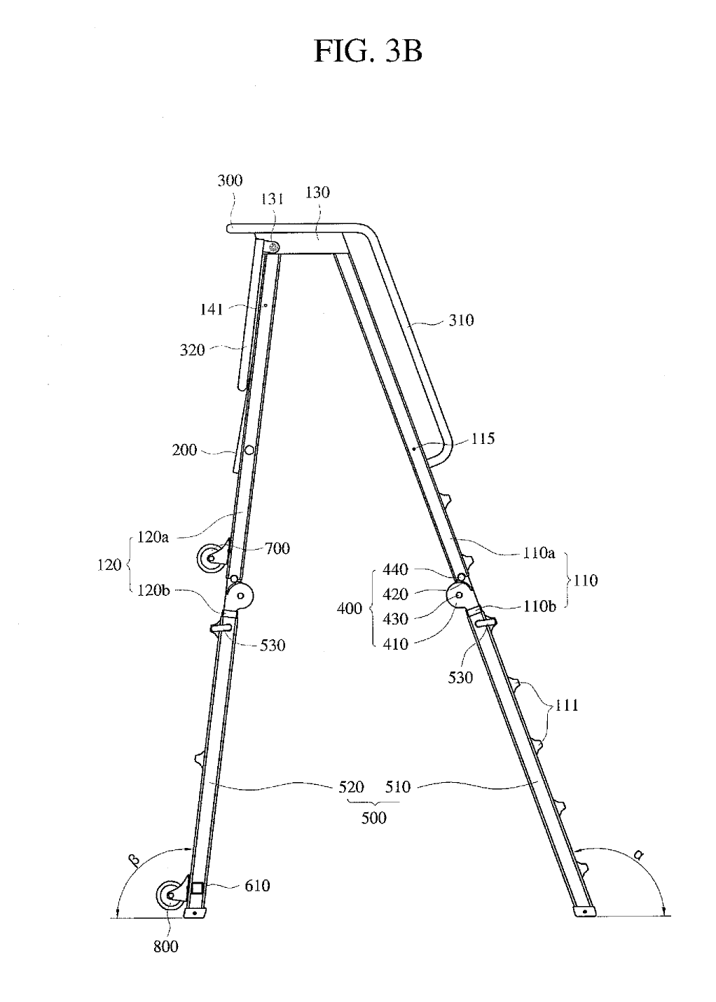

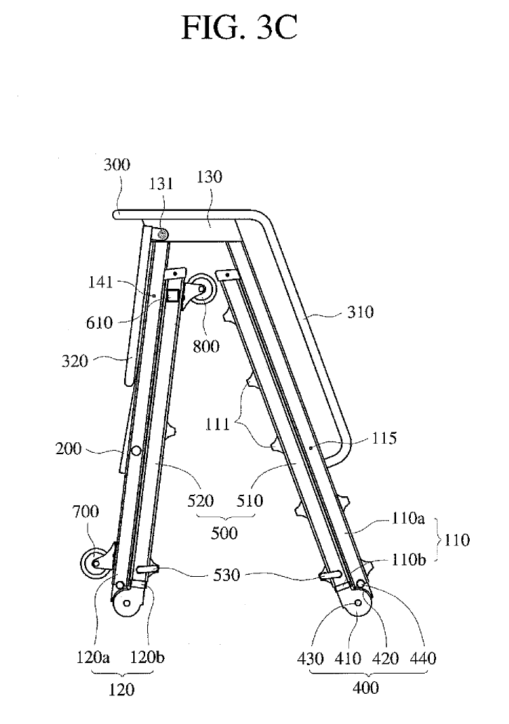

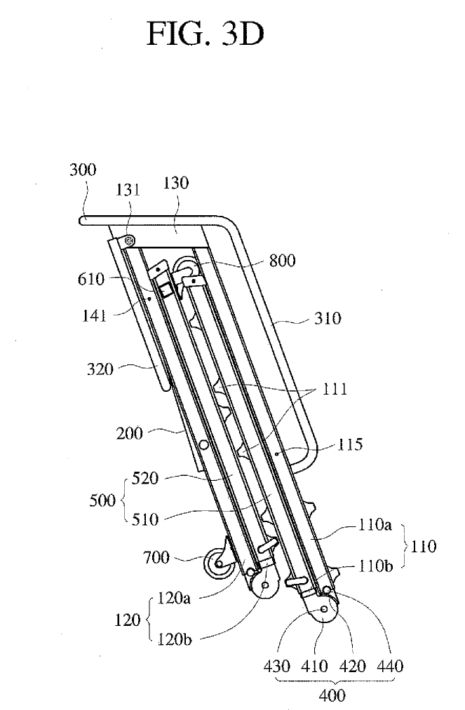

Hereinbelow, function of the ladder having the above-described configuration will be described with reference to the accompanying drawings FIGS. 3A to 3D.

FIG. 3A shows a ladder which is supported to the ground and is arranged and used in a necessary working area.

Here, the position transfer wheels 800 of the ladder is inclined so that the ladder contacts the ground in order to change one work position into another working position by carrying the ladder from one work position to another working position.

Then, the ladder is pushed to move to a necessary work position.

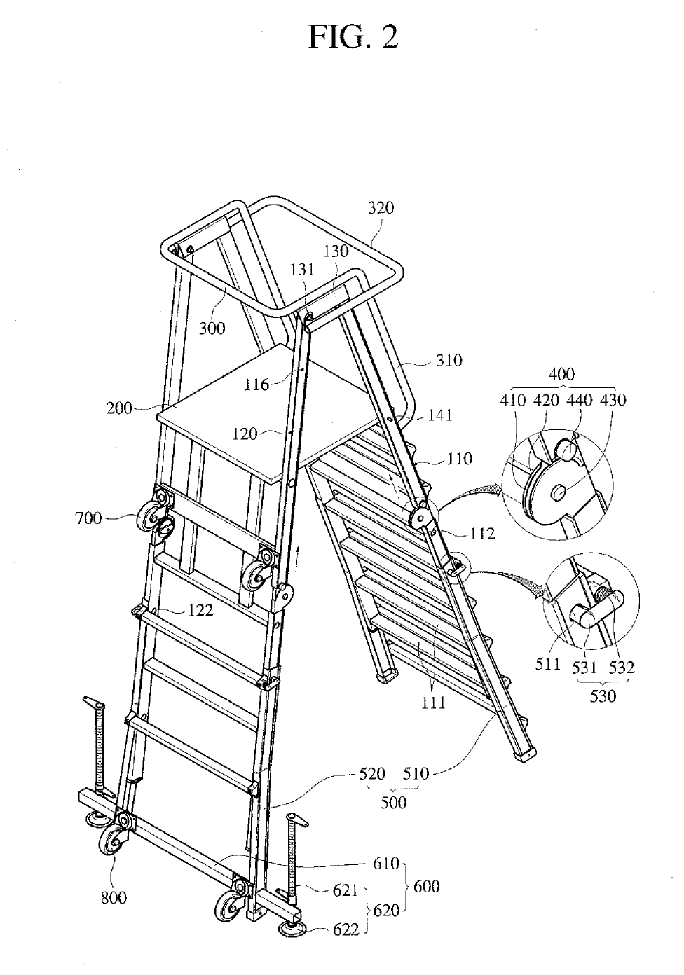

As illustrated in FIG. 2, in order to control height of the ladder, the first support 110 and the second support 120 are made to ascend from the first auxiliary leg 510 and the second auxiliary leg 520, respectively.

Then, the pins 531 of the control units 530 are used to be inserted into the throughholes 511 and 521 of the first and second auxiliary legs 510 and 520 and the insertion holes 112 and 122 of the first and second supports 110 and 120, to thereby constrain height of the first and second supports 110 and 120.

Meanwhile, in order to carry the ladder to a predetermined storage place so as to be kept in custody after a ladder work has been finished, the ladder should be folded as follows to minimize volume of the ladder.

First of all, the other side of the constrained foothold 200 is released and then the foothold 200 is made to rotate toward the second support 120, as illustrated in FIG. 3B.

In this case, the fixing pin 141 is made to secede from the first fixing hole 115, using the exit and entrance handles 142 of the fixing unit 140, and then the foothold 200 is made to rotate toward the second support 120.

Thereafter, if the exit and entrance handles 142 are released, the fixing pin 141 is inserted into the second fixing hole 116 formed in the second support 120, to thereby constrain movement of the foothold 200.

Then, the auxiliary safety bar 320 is made to rotate toward the front side of the ladder around the other end of the fixed bracket 130.

Accordingly, the auxiliary safety bar 320 is arranged on the second support 120.

Then, the first support 110 and the second support 120 are made to rotate toward the inner side of the ladder and are folded as illustrated in FIG. 3C.

Then, the second support 120 is made to rotate toward the first support 110 around the other end of the fixed bracket 130.

Accordingly, as illustrated in FIG. 3D, the ladder is completely folded.

In this case, as can be seen from the drawing, the state that the ladder has been folded is the state that the ladder is inclined with respect of the surface of the ground.

This is due to the first support 110 that is fixed to the fixed bracket 130 by a predetermined tilt with respect to surface of the ground. That is, since the first support 110 of the inclined state becomes a basis of the folded ladder, the ladder that has been completely folded becomes a state where the ladder has been inclined with respect to surface of the ground.

Thus, since the ladder that has been completely folded becomes inclined, the transport wheels 700 can easily contact the ground.

As a result, the worker can easily transport the ladder at a state where he or she safely grasps the safety bar 300.

The ladder equipped with a safety bar according to the present invention has the following effects.

Firstly, since the respective supports are folded, volume of the ladder can be minimized.

Accordingly, a space efficiency of keeping the ladder in custody is maximized.

Further, even in the case of transporting the ladder by using a truck, a space efficiency of loading ladders in the truck is maximized, to thus enhance an economy of a cost of transport of the ladders.

Secondly, since transport wheels and position transfer wheels are installed in the second support, the ladder can be conveniently transported even at a state where the ladder has been folded or unfolded.

The present invention is not limited to the above-described embodiment. It is apparent to one who has an ordinary skill in the art that there may be many modifications and variations within the same technical spirit of the invention.

What I claim is:

1. A ladder equipped with a safety bar, the ladder comprising:
a first support supported on the ground, including a plurality of horizontal bars;
a fixed bracket whose one end portion is fixed to the upper portion of the first support;
a second support which is rotatably combined with the other end portion of the fixed bracket;
a foothold that is placed between the first and second supports and is rotatably combined toward the second support on one side, thereby offering a working space;
a safety bar which is installed in a C-shaped fashion toward the front side from the fixed bracket, thereby securing a front-side safety of a worker by preventing the worker from falling down from the foothold to the front side; and
rotating devices which are installed in the first and second supports, respectively, and folds and unfolds the first and second supports, wherein each of the rotating devices comprises:
a first circular rotating unit along the outer circumferential surface of which a groove is formed;
a second circular rotating unit which is rotatably inserted into the groove of the first rotating unit; and
a hinge axis which penetrates centers of the first rotating unit and the second rotating unit and axially combines the first rotating unit and the second rotating unit each other.

2. The ladder equipped with a safety bar according to claim 1, wherein an angle of the first support with respect to the ground is larger than that of the second support with respect to the ground.

3. The ladder equipped with a safety bar according to claim 1, wherein a plurality of insertion holes are formed at both sides of the first and second supports, respectively, and height control devices are further installed in the first and second supports, respectively, wherein each of the height control devices comprises:
a first auxiliary leg in which the first support is slid and the plurality of the insertion holes are installed, and which comprises throughholes communicating with the insertion holes;
a second auxiliary leg in which the second support is slid and which comprises throughholes communicating with the insertion holes; and
control units which are installed in the first and second supports, respectively, and inserted into the throughholes of the first and second auxiliary legs and the insertion holes of the first and second supports, thereby constraining ascent and descent of the first and second supports.

4. The ladder equipped with a safety bar according to claim 3, wherein intervals between the insertion holes formed in the first support are larger than those of the insertion holes formed in the second support.

5. The ladder equipped with a safety bar according to claim 1, wherein transport wheels are further installed above the second support.

6. The ladder equipped with a safety bar according to claim 3, wherein position transfer wheels and foot bars are further installed at both sides of the second auxiliary leg, respectively, and each of the foot bars comprises a support bar which pierces the second auxiliary leg and a close adhesion portion which is placed on one end of the support bar and closely contacts the ground.

7. The ladder equipped with a safety bar according to claim 1, wherein an auxiliary safety bar which is rotatably combined with on the other end of the fixed bracket, and which is installed in a C-shaped fashion toward the rear side from the fixed bracket, thereby securing a rear-side safety of the worker by preventing the worker from falling down from the foothold to the rear side, is further installed in the fixed bracket.

8. The ladder equipped with a safety bar according to claim 1, wherein a fixing unit which constrains rotation of the foothold is further installed in the other side of the foothold and fixing holes are further installed in the first and second supports in correspondence to the fixing unit, wherein the fixing unit comprises:
fixing pins which are installed at both sides of the foothold, respectively, and enter into and exit from the fixing holes;
a pair of exit and entrance handles which make the fixing pins enter into and exit from the fixing holes; and
a spring which is installed between the exit and entrance handles.
